(19) United States
(12) Patent Application Publication
(10) Pub. No.: US 2021/0245048 A1
(43) Pub. Date: Aug. 12, 2021

(54) SCORING SYSTEM FOR SCENT WORK SPORTS

(71) Applicant: David Moczulski, Ellicott City, MD (US)

(72) Inventor: David Moczulski, Ellicott City, MD (US)

(21) Appl. No.: 17/240,144

(22) Filed: Apr. 26, 2021

Related U.S. Application Data
(60) Provisional application No. 63/146,940, filed on Feb. 8, 2021.

(51) Int. Cl. A63F 13/46

(52) U.S. Cl. CPC A63F 13/46

(57) ABSTRACT

A scoring system and method for Nosework trials that can digitally evaluate the Nosework trials. The data can be easily shared with the concerned governing bodies and the participants. Several interfaces can be provided on a user device for judging and scoring aspects of the Nosework trails. Moreover, the disclosed system allows computing the results in near real-time.

### CROSS-REFERENCE TO RELATED APPLICATIONS

This application claims priority to the U.S. provisional patent application Ser. No. 63/146,940, filed on Feb. 8, 2021, which is incorporated herein by reference in its entirety.

### FIELD OF INVENTION

The present invention relates to a scoring system for scent work/nose work sports/trials.

### BACKGROUND

Nosework, also known as scent work, is a popular sport for dogs in which a dog must find a specific odor. The sport is played as a team of one dog and one handler. Nosework is typically based on the detection dog's tasks. In the united states, the National Association of Canine Scent Work (NACSW) and United Kennel Club (UKC) Nosework are two main governing bodies for Nosework. Like other sports games, judges evaluate the performance of dogs in the sport of trials. Generally, a lot of parameters are evaluated in the game that span over days.

A few days before the start of each trial, the trial host can download score sheets for each competitor for their trial weekend. Details of the participants must be taken in multiple copies which are distributed among copiers and governing bodies. During the trials, dogs are evaluated on a range of parameters that are recorded on the score sheets. As an example, a NACSW NW3 trial can have approximately 35 dogs.

Each dog does 6 searches at that level. Each search has its score sheet, which is 210 sheets of paper. A minimum of 2 copies are required (one for a competitor, one returned to NACSW), so the count increases to 420 to 630 sheets of paper just for score sheets. Thereafter, on each day of the event, all of the results are printed multiple times. NACSW trials are 2-3 days, so the average trial is using a couple of thousand sheets of paper (plus ink). At some other events (like AKC Agility) there could be hundreds of dogs in a single event.

Judges are usually assisted by volunteers in recording the details and score. Such a process is both laborious and costly as a stack of sheets is produced. Also, the use of paper is not favored as being environmentally unfriendly. Thus, a desire is there for a computing system that can be used to evaluate the Nosework trials.

Hereinafter, the terms “judge” and “evaluator” are interchangeably used and refer to a person evaluating the Nosework trial. The phrased “Nosework” and “scent work” are interchangeably used and refer to a canine sport based on detection of hidden odor, also referred herein as hides.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a scoring system and a method for scoring a Nosework trial.

It is another object of the present invention that the scoring system replaces the paper-based scoring systems.

It is still another object of the present invention that the scoring system is easy to use.

It is yet another object of the present invention that the scoring system provides results in near real-time.

In one aspect, disclosed is a scoring system for Nosework trials that can digitally record the details and scores of the Nosework trials. The data can be easily shared with the concerned governing bodies and the participants.

In one aspect, disclosed is an interface that can be provided on a user device for judging and scoring aspects of the Nosework trails. Moreover, disclosed is an interface that allows computing the results.

In one aspect, the disclosed system can also include a timer for timekeeping in the event. The system can provide alerts and warnings through an inbuilt vibrator and/or audio alarms.

These and other objects and advantages of the embodiments herein and the summary will become readily apparent from the following detailed description taken in conjunction with the accompanying drawings

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows an exemplary embodiment of the interface on a user device for importing a run order, according to the present invention.

FIG. 2 shows another exemplary embodiment of the interface to enter search criteria, according to the present invention.

FIG. 3 shows another exemplary embodiment of the interface showing the evaluator's search selection, according to the present invention.

FIG. 4 shows an exemplary embodiment of a blank score sheet, according to the present invention.

FIG. 5 shows another exemplary embodiment of the interface that can be presented on the evaluator's device displaying the near real-time result of the event, according to the present invention.

FIG. 6 shows another exemplary embodiment of the interface showing a completed score sheet, according to the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is an electronic scoring system for canine Nosework trails/sports/events that can replace the paper-based judging and scoring system currently used. Also is disclosed a method of scoring the Nosework trial using the disclosed system. The disclosed system by saving paper is environmentally friendly. Moreover, saves the cost of paper and labor as less reliance on human volunteers. Scores can be calculated quickly and presented in near real-time. Human errors can be minimized, such as entering wrong entries on paper or copying incorrect values from the paper. The disclosed system can also be carried easily, and entries can be made without a pen. In one aspect, the disclosed scoring system can provide an interface that can be downloaded on a user device. The interface can be provided as application software that can be installed on the user device or evaluator's device. The application software can be developed for Android, iOS, and any other known operating platform for mobile devices. The application software can be made available through a distribution service provider, for example, Google Play operated and developed by Google, and the app store by Apple. In addition to the application software, a website-based interface can also be provided through the world-wide-web. The user device can be any portable computing device, such as a smartphone, tablet computer, and like. The portable computing device can have an input mechanism for entering details. For example, the computing device can have a touch interface to manipulate entries.

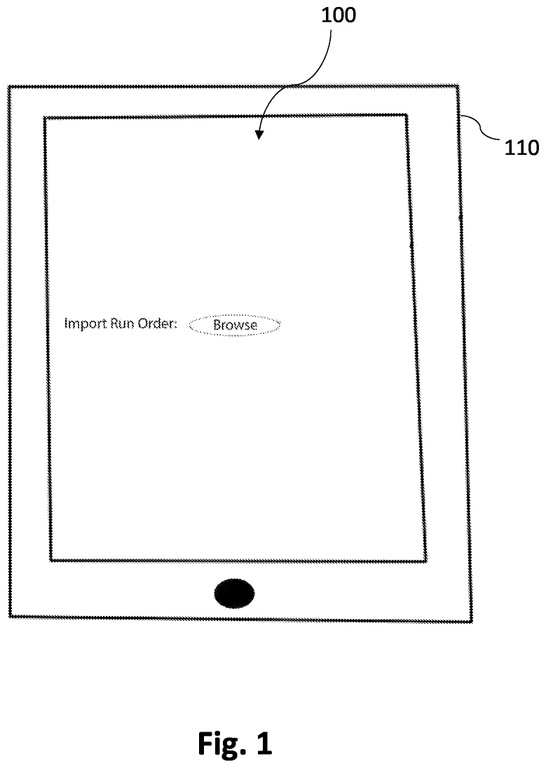

Referring to FIG. 1, which shows an exemplary embodiment of the interface 100 provided on a user device 110. The user device 110 shown in FIG. 1 can be a tablet computer, such as an iPad from the manufacture Apple. The user device 110 can be connected to a server or cloud which allows sharing data between different user's devices and the computing system of the judges, for example, the computing system in a scoring room. The devices can be connected through a wireless connection, such as Wi-Fi or cellular networks. Network for connecting the user devices to the server may not be always available at all places. The disclosed scoring system can record the entries offline and share them with the server when the external network is available.

The interface 100 shown in FIG. 1 can be used to receive a run order with dog and handler information before the start of the event. The disclosed system can provide multiple embodiments of interfaces that can be switched through a menu bar. Each interface can provide different functionalities for judging and scoring the event. The user can browse the import run order using the file system of the user device. Once loaded, the interface can display the competitor data.

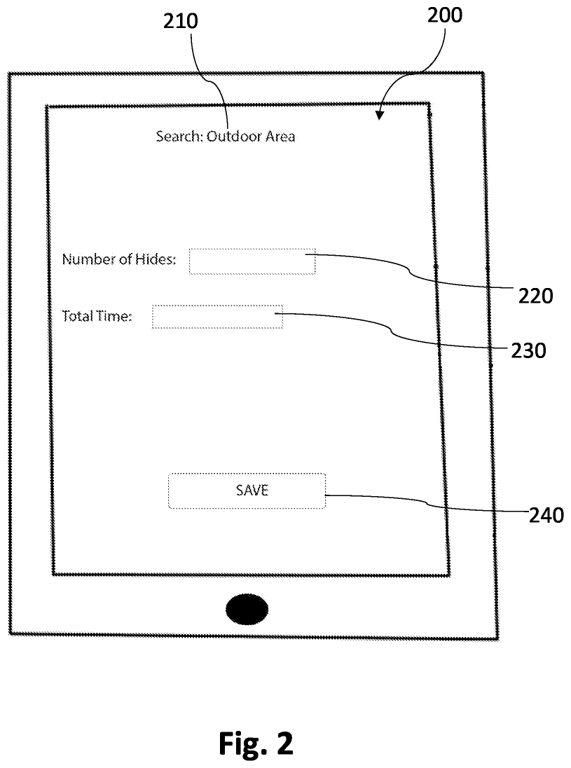

Referring to FIG. 2, which shows another exemplary embodiment of the interface 200 for entering the search criteria. Depending on organization and level of competition, the number of scent hides to be found and the amount of time a competitor has may not be known until the day of the event. These options can also be configured using the interface 200 shown in FIG. 2. The interface 200 can have a field 210 for entering the search criteria. Field 220 can be used to enter the number of hides. The total search time can also be entered through field 230. The entries can be saved by clicking the save bottom 240.

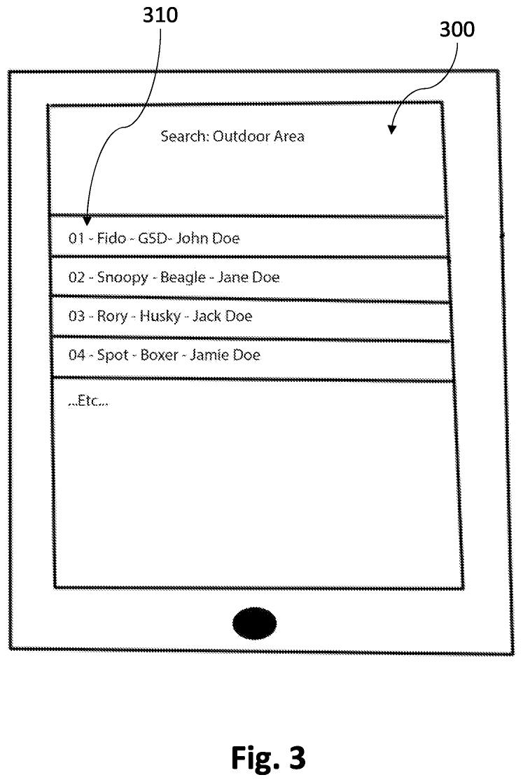

Referring to FIG. 3 which shows another exemplary embodiment of the interface 300 for the judge's search selection. Once all event data can be loaded and the user devices are handed to the judges for scoring the event. During each search of the event, the judge can select the dog and handler team from the list. At the top of the interface can be seen the name of the search event, such as the outdoor area. The evaluator or judge can tab an entry 310 in the list of participants that opens a blank sheet.

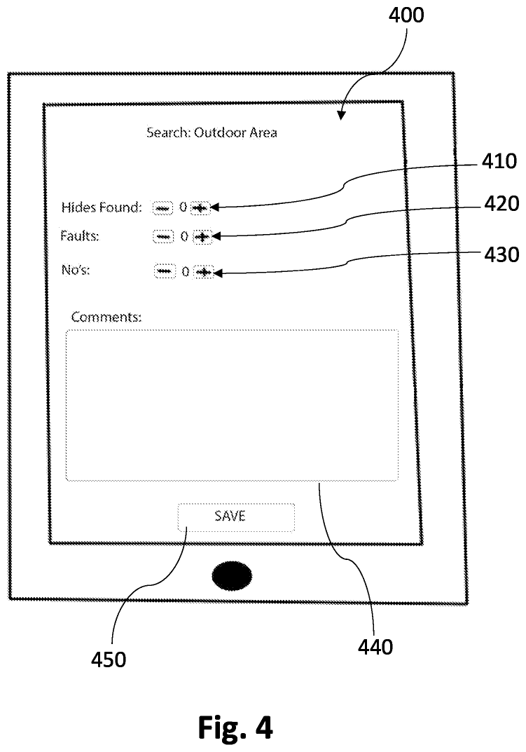

An exemplary embodiment of the empty score sheet 400 is depicted in FIG. 4. The judge or evaluator can provide their input through the empty score sheet 400. For example, for every hide found, the evaluator can increase the counter 410. The counter 410 can include two click buttons and can be used to increase or decrease the value of the counter. The evaluator can both increase and decrease the number of hides found. The current value of the hides found can also be displayed adjacent the counter 410. The number of faults can also be entered using counter 420. The number of alert calls can also be entered and modified using counter 430. The empty score sheet 400 can also have an option in the form of a free form comment box 440 that can be used for entering comments for the participants. A click save button 450 can also be provided that allows saving the input data on the blank scoring sheet 400.

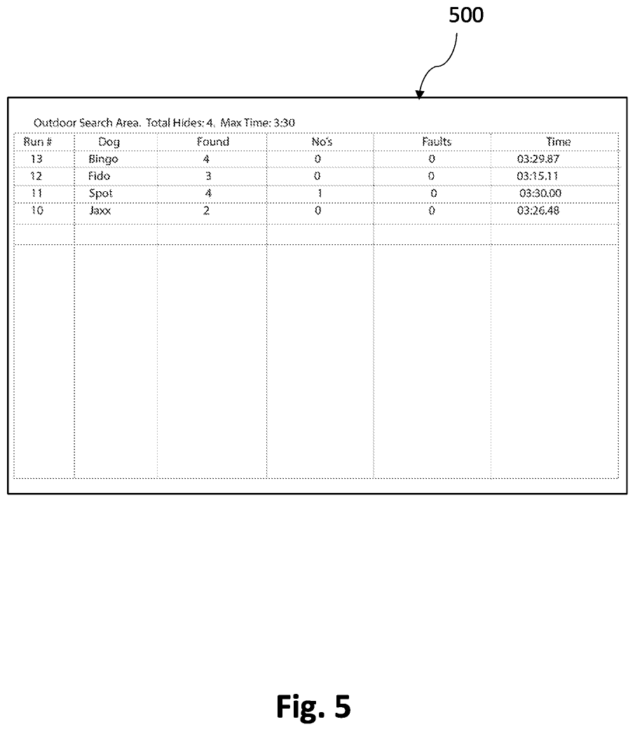

Referring to FIG. 5 which shows another exemplary embodiment of the interface 500 that can be presented on an evaluator device. The interface 500 can show in near real-time the results of the event. The evaluator device can receive the data of all the participants at end of the event or in near real-time. The data of all the participants can be rendered by the evaluator device, wherein the interface 500 can display the results.

It is obvious that the different governing bodies may have different scoring rules, and the disclosed interface can be easily adapted to different rules. Additionally, a stylus can be used instead of a finger for ease of input. Types of the stylus or any other input that can be used may depend on the user device. The interface can provide a free form comment box that can be used to note comments for the participants. For example, the evaluator can leave comments for the participant.

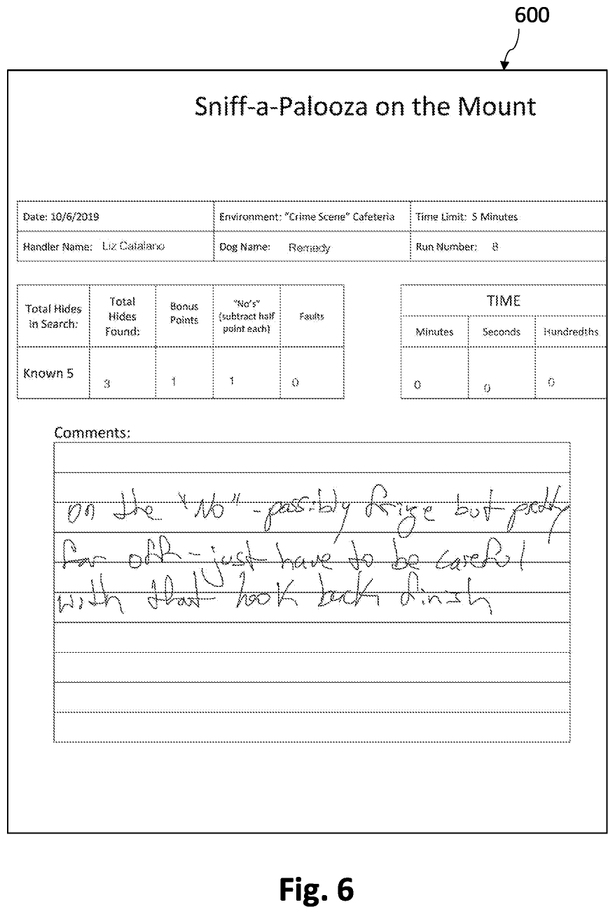

At the conclusion of the event, a copy of each score sheet could be made available to the participants electronically using another embodiment of the interface 600 shown in FIG. 6. The disclosed scoring system can be used by Nosework organizations and trial hosts to simplify and speed up the scoring process at events. The disclosed system can eliminate the need to print multi-part paper score sheets that is environmentally friendly. Since a counter can be provided on the interface of increasing or decreasing a value, the evaluator's job becomes easier and required less writing. Since there is no writing on paper or typing data from paper, the efficiency increases, redundancy decreases, and human error can be substantially eliminated.

Using the integrated environment through wireless external networks, all score calculations can be instant and save a lot of time as well as reliance on other volunteers.

In one exemplary embodiment, the disclosed system may also provide a timer for timekeeping in the event. The integrated timer can eliminate manual entry and human error in timekeeping. Sometimes the timekeeper is watching the dog and not the stopwatch, so they forget to give a 30-second warning. The disclosed system can vibrate or audibly let the judge know there are 30 seconds left so they can alert the competitor.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer-implemented method for scoring a canine Nosework trial, the method comprising the steps of:
providing a first interface, on a user device, wherein the first interface is configured to receive a name of search area, number of hides in the Nosework trial, and the total time in the Nosework trial;
providing a second interface, wherein the second interface is configured to show a list of teams in the Nosework trial, wherein each entry in the list is linked to a score sheet, the score sheet comprises a plurality of fields configured to receive a score data, the score data comprises number of hides found by a team and number of faults;
transmitting, the score data to a central computing system through a wireless network, wherein the central computing system is configured to compute a result from a plurality of score data from a plurality of score sheets of a plurality of teams in the Nosework trial;
receiving the result, through the wireless network, from the central computing system; and
providing a third interface for presenting the result.

2. The method according to claim 1, wherein the method further comprises the steps of:
receiving, by the user device, the plurality of score sheets, from the central computing system through the wireless network; and
providing a fourth interface, on the user device, for presenting the plurality of score sheets.

3. The method according to claim 1, wherein the method further comprises the steps of:
providing a digital stopwatch, on the user device, for timekeeping in the Nosework trial.

4. The method according to claim 1, wherein the score sheet comprises a comment box for providing comments to the team.

5. The method according to claim 1, wherein each field of the plurality of fields in the score sheet is having a counter, the counter having two clickable buttons configured to increase or decrease a value of the field, wherein the counter configured to display the value of the field.

6. A scoring system for a canine Nosework trial, the scoring system comprises:
an input interface to receive an input,
a processor and a memory operably coupled to the processor, the memory includes a set of instructions which when executed by the processor causes the processor to:
provide a first interface wherein the first interface is configured to receive name of search area, number of hides in the Nosework trial, and the total time in the Nosework trial;
provide a second interface, wherein the second interface is configured to show a list of teams in the Nosework trial, wherein each entry in the list is linked to a score sheet, the score sheet comprises a plurality of fields configured to receive a score data, the score data comprises number of hides found by a team and number of faults;
transmit the score data to a central computing system through a wireless network, wherein the central computing system is configured to compute a result from a plurality of score data from a plurality of score sheets of a plurality of teams in the Nosework trial;
receive the result, through the wireless network, from the central computing system; and
provide a third interface for presenting the result.

7. The scoring system according to claim 6, wherein the processor further:
receive the plurality of score sheets, from the central computing system through the wireless network; and
provide a fourth interface for presenting the plurality of score sheets.

8. The scoring system according to claim 6, wherein the processor further:
provide a digital stopwatch for timekeeping in the Nosework trial.

9. The scoring system according to claim 6, wherein the score sheets comprise a comment box for providing comments to the team.

10. The scoring system according to claim 6, wherein each field of the plurality of fields in the score sheet is having a counter, the counter having two clickable buttons configured to increase or decrease a value of the field.
